(19) United States
(12) Patent Application Publication
(10) Pub. No.: US 2007/0044019 A1
(43) Pub. Date: Feb. 22, 2007

(54) Multi-campaign assignment apparatus considering overlapping recommendation problem

(76) Inventor: Byung-Ro Moon, Seoul (KR)

Correspondence Address: IPLA P.A., 3580 WILSHIRE BLVD., 17TH FLOOR, LOS ANGELES, CA, 90010, US

(21) Appl. No.: 10/556,266

(22) PCT Filed: May 19, 2004
(86) PCT No.: PCT/KR04/01189

§ 371 Date: Nov. 14, 2005

(30) Foreign Application Priority Data
May 23, 2003 (KR) 10-2003-0032812

(51) Int. Cl. G06F 3/00; G07G 1/00

(52) U.S. Cl. 715/700; 705/10

(57) ABSTRACT

A multi-campaign assignment apparatus considers overlapping recommendation occurring when a plurality of personalized campaigns are simultaneously performed, thereby increasing marketing efficiency and client satisfaction. The multi-campaign assignment apparatus extracts clients' preferences for each campaign, predicts the clients' reactivities to overlapping recommendation of campaigns, and performs two-dimensional campaign-client assignment using the preferences and a reactivity function to maximize the marketing efficiency. The multi-campaign assignment apparatus includes a client preference extractor, a reactivity function determiner, a limit condition provider, a campaign-client assignment evaluator, and a client selector.

### TECHNICAL FIELD

The present invention relates to a multi-campaign assignment apparatus, and more particularly, to a multi-campaign assignment apparatus which selects clients considering an overlapping recommendation problem when multiple campaigns are simultaneously performed, thereby increasing marketing efficiency.

### BACKGROUND ART

Recently, as the number of personalized campaigns increases, it frequently happens that multiple campaigns are simultaneously performed. When the number of personalized campaigns simultaneously performed increases, an overlapping recommendation problem in that a client is recommended multiple campaigns simultaneously may occur. A client having a high preference for a certain campaign usually has a high preference for other campaigns. Accordingly, if multiple campaigns are simultaneously and independently performed without considering the overlapping recommendation problem, a particular client may be simultaneously recommended many campaigns. As the number of overlapping recommendations made to a single client increases, the clients' interest in campaigns decreases. As a result, the client's reactivity to each campaign decreases. Consequently, the overlapping recommendation problem decreases client satisfaction and marketing efficiency. In a worst case, a client may withdraw from a company or turns away the company's campaigns through filtering. It is very important to optimally assign campaigns to clients in consideration of the overlapping recommendation problem in order to increase marketing efficiency and client satisfaction in a situation where multiple campaigns are simultaneously performed.

Conventionally, marketing schemes usually do not consider the overlapping recommendation problem. Tables 1 through 4 illustrate importance of multi-campaign marketing considering the overlapping recommendation problem.

TABLE 1
Client's preference for a campaign

| | Campaign1 | Campaign2 | Campaign3 |
|---|---|---|---|
| Client1 | 100 | 98 | 80 |
| Client2 | 70 | 48 | 13 |
| Client3 | 50 | 77 | 62 |
| Client4 | 34 | 4 | 61 |
| Client5 | 9 | 90 | 70 |

TABLE 2
Client's reactivity function value

| | Campaign1 | Campaign2 | Campaign3 |
|---|---|---|---|
| Reactivity | 1.0 | 0.7 | 0.5 |

TABLE 3
Preference · Reactivity = 415.5

| | Campaign1 | Campaign2 | Campaign3 |
|---|---|---|---|
| Client1 | 1 | 1 | 1 |
| Client2 | 1 | 0 | 0 |
| Client3 | 1 | 1 | 1 |
| Client4 | 0 | 0 | 0 |
| Client5 | 0 | 1 | 1 |

TABLE 4
Preference · Reactivity = 483

| | Campaign1 | Campaign2 | Campaign3 |
|---|---|---|---|
| Client1 | 1 | 1 | 0 |
| Client2 | 1 | 0 | 0 |
| Client3 | 0 | 1 | 1 |
| Client4 | 1 | 0 | 1 |
| Client5 | 0 | 1 | 1 |

Table 1 shows an example of clients' preferences for campaigns. There are three campaigns and five clients. It is assumed that each campaign should be recommended for three clients. Referring to Table 2, all of the clients have the same reaction to overlapping recommendation, and the clients' reactivity to each campaign is sequentially reduced to 0.7 and 0.5 when the number of recommendations sequentially increases to two and three.

When recommendation is independently made on multiple campaigns in conventional marketing schemes, as shown in Table 3, client1 and client3 are recommended three campaigns, and client5 is recommended two campaigns. Accordingly, a target value that is the sum of products of an individual client's preference and reactivity is 415.5 when the multiple campaigns are independently and optimally performed. However, as shown in Table 4, the target value is 483, and thus marketing efficiency becomes much higher when recommendation is distributed among the clients in consideration of the overlapping recommendation problem. Tables 1 through 4 prove that a multi-campaign assignment method considering the overlapping recommendation problem increases marketing efficiency.

### DISCLOSURE OF THE INVENTION

The present invention provides a multi-campaign assignment apparatus which assigns campaigns to a client in consideration of the client's reactivity to overlapping recommendation when multiple campaigns are simultaneously performed, thereby increasing marketing efficiency.

According to an aspect of the present invention, there is provided a multi-campaign assignment apparatus considering an overlapping recommendation problem, including a client preference extractor extracting a client's preference for a campaign based on the client's personal information and the client's action history log by using at least one among cooperative filtering, a neural network, a genetic algorithm, and a genetic programming method; a reactivity function determiner determining overlapping recommendation when a client is recommended multiple campaigns within a predetermined period of time and determining a reactivity function of client reactivity to overlapping recommendation; a limit condition provider determining a number of clients to be assigned to each campaign in consideration of the characteristics and environment of each campaign; a campaign-client assignment evaluator predicting and evaluating a result of assigning clients to a campaign; and a client selector generating a matrix having clients at a row and campaigns at a column based on client preference, client reactivity, and campaign limit conditions and selecting clients to be recommended a campaign using a client assignment algorithm in a state where no clients are recommended any campaign.

### BRIEF DESCRIPTION OF THE DRAWINGS

FIG. 1 illustrates a structure of a computer system in which a multi-campaign assignment apparatus according to an embodiment of the present invention is implemented.

FIG. 2 is a functional block diagram of the multi-campaign assignment apparatus according to an embodiment of the present invention.

FIG. 3 is a flowchart of a constructive assignment algorithm used in the present invention.

### BEST MODE FOR CARRYING OUT THE INVENTION

Hereinafter, a structure and operations of an embodiment of the present invention will be described in detail with reference to the attached drawings.

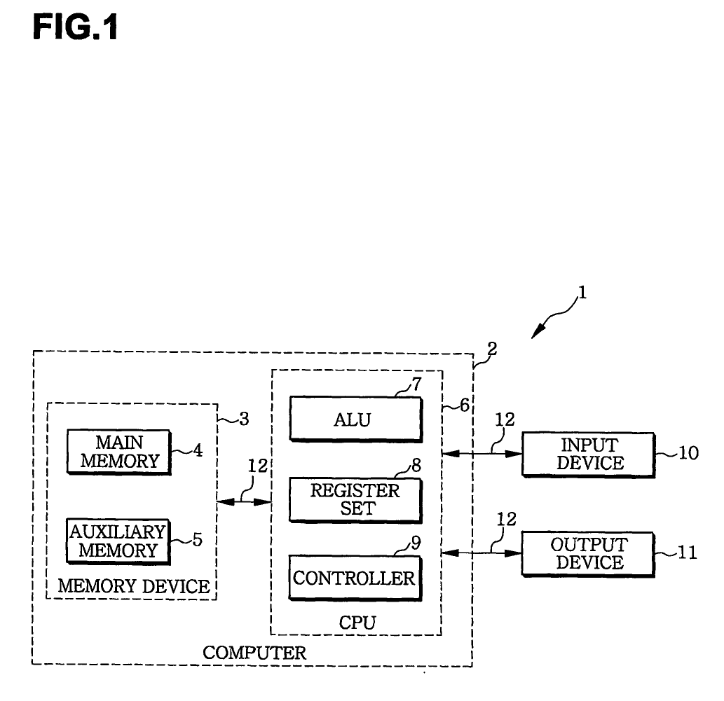

Referring to FIG. 1, a computer system 1 in which a multi-campaign assignment apparatus according to an embodiment of the present invention is implemented includes a computer 2 having at least one central processing unit (CPU) 6 and a memory device 3, an input device 10, and an output device 11. The elements of the computer system 1 are connected with one another by at least one bus structure 12.

The CPU 6 includes an arithmetic/logic unit (ALU) performing an arithmetic operation and a logic operation, a register set 8 temporarily stores data and commands, and a controller 9 controlling operations of the computer system 1. The CPU 6 used for the present invention is not restricted to a particular structure made by a particular manufacturer, but any type of processor having the above-described basic structure can be used.

The memory device 3 includes high-speed main memory 4 and auxiliary memory 5 for long-term data storage. The main memory 4 is implemented by a random access memory (RAM) chip and a read-only memory (ROM) chip. The auxiliary memory 5 is implemented by a floppy disc, a hard disc, CD-ROM, flash memory, and/or a device storing data using electricity, magnetism, light, or other recording media. In addition, the main memory 4 may include video display main memory used to display images via a display device. It will be understood by those skilled in the art that the memory device 3 may include other various replaceable elements having various storage functions.

The input device 10 may include a keyboard, a mouse, a physical converter (e.g., a microphone), etc. The output device 11 may include a display device, a printer, a physical converter (e.g., a speaker), etc. Alternatively, a device such as a network interface or a modem may be used as an input/output device.

The computer system 1 includes an operating system and at least one application program. The operating system is software controlling the operations of the computer system 1 and resource assignment, and the application program is software executing a job requested by a user by using computer resources available through the operating system. The operating system and the application program are stored in the memory device 3. Consequently, a multi-campaign assignment apparatus according to the embodiment of the present invention may be implemented by at least one application program installed and operated in the computer system.

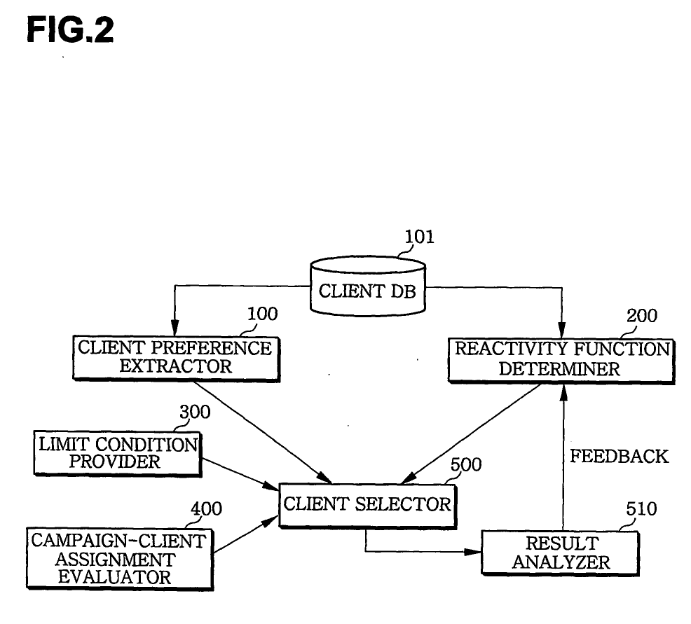

Referring to FIG. 2, the multi-campaign assignment apparatus according to the embodiment of the present invention functionally includes a client preference extractor 100, a reactivity function determiner 200, a limit condition provider 300, a campaign-client assignment evaluator 400, a client selector 500, and a result analyzer 510.

The client preference extractor 100 extracts a client's preference for a campaign based on the client's personal information and the client's action history log, which are obtained from a client database (DB) 101, by selectively using cooperative filtering, a neural network, a genetic algorithm, a genetic programming method, etc. The client's preference for a campaign may be represented by a numerical value.

The reactivity function determiner 200 determines a reactivity function of a probability of a client reacting to overlapping recommendation on campaigns. The reactivity function usually decreases as the number of overlapping recommendations increases. When a client's preferences for campaign1 and campaign 2 are 100 and 150, respectively, if only one of the campaigns is recommended for the client, the client's reaction can be predicted to be the same as the client's preference. However, when a client's reactivity to overlapping recommendation is 0.9 and the client is simultaneously recommended campaign1 and campaign2, the client's reaction is predicted like the client's preferences for the campaign1 and the campaign2 are decreased to 90 and 135, respectively. The reactivity function can be made using various assumptions based on whether the same reactivity function is applied to all clients and all campaigns.

In a simplest mode, the same reactivity function may be applied to all clients. Alternatively, clients may be classified into groups based on their personal information and action history logs obtained from the client DB 101 and different reactivity functions may be applied to the groups, respectively. In the same manner, the reactivity function is applied to campaigns subjected to overlapping recommendation. The same reactivity function may be applied to all overlapping recommendations on campaigns, or different reactivity functions may be applied to overlapping recommendation according to what campaigns are subjected to overlapping recommendation based on campaign attribute information and clients' action history logs with respect to campaigns.

The limit condition provider 300 determines the numbers of clients (e.g., a minimum number of clients, a maximum number of clients, etc.) to be assigned to each campaign in consideration of the characteristics and environment of each campaign.

The campaign-client assignment evaluator 400 provides a formal method of predicting and evaluating a result of assigning clients to a campaign.

The client selector 500 selects clients to be recommended a campaign and to give a maximum reaction rate based on each client's preference and reactivity, campaign limit conditions, and the assignment evaluation method. The selection is performed using a heuristic algorithm, a dynamic program, a Lagrange multiplier, a genetic algorithm, or a combination of two of those. Recommendation of a campaign for a client is represented by a binary matrix made using “0” and “1”, where “1” indicates recommendation. The client selector 500 may put a weight on a campaign in consideration of the campaign's importance or balance among campaigns. In addition, the client selector 500 may define the overlapping recommendation as a case where a client is recommended multiple campaigns within a predetermined period of time. As such, the client selector 500 may select clients to be recommended a campaign based on the weight and the overlapping recommendation.

There are various methods of selecting clients to be recommended each campaign among multiple campaigns. One is a constructive assignment algorithm.

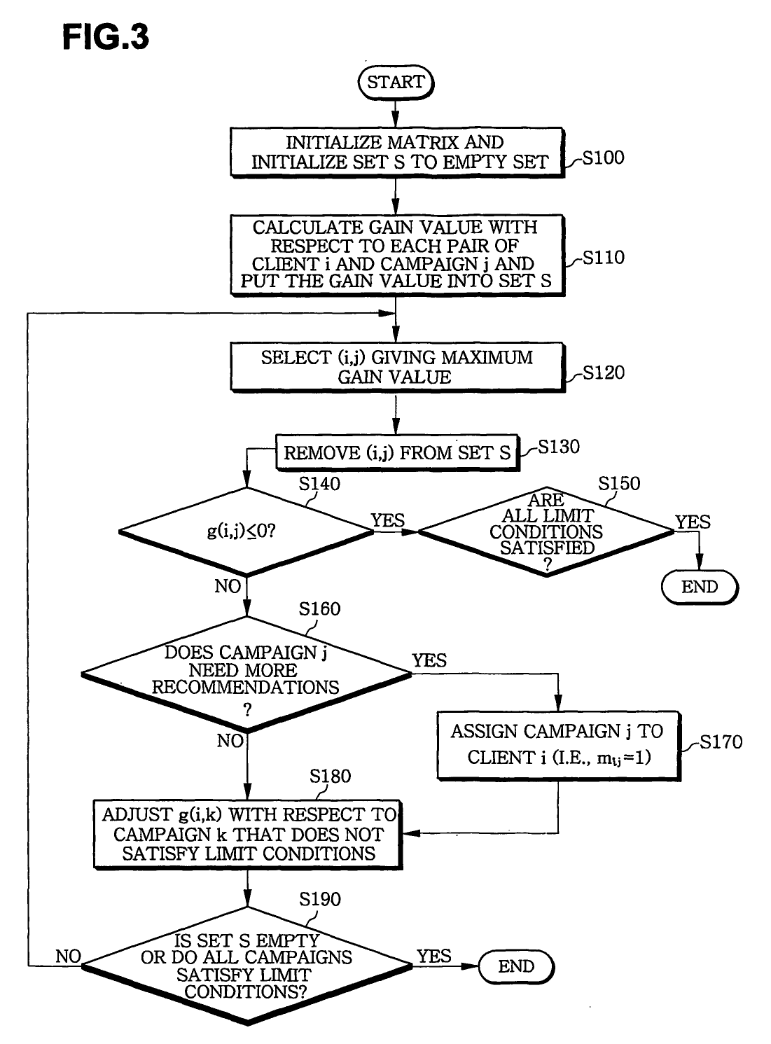

FIG. 3 is a flowchart of the constructive assignment algorithm. A matrix is initialized and a set S is initialized to an empty set so that no clients are assigned to any campaign in operation S100. Thereafter, a gain value g_{(i,j)} in a case where a client i is recommended a campaign j is calculated and is put into the set S in operation S110. Here, the gain value g_{(i,j)} may be calculated using Formula (1).
g_{(i,j)}=R(Hᵢ+1)·(σᵢ+fⱼ(i))−R(Hᵢ)·σᵢ (1)

Here, Hᵢ is the number of recommendations made to the client i, fⱼ(i) is a preference of the client i for the campaign j, σᵢ is the sum of preferences of the client i for campaigns that have been recommended to the client i, and R(Hᵢ) is a reaction rate of the client i with respect to the number of recommendations, Hᵢ.

Thereafter, among all available pairs (client, campaign), a pair (client, campaign) giving a maximum gain value is assigned “1” in operation S120, and the pair (client, campaign) giving the maximum gain value is removed from the set S.

Until there is no gain and all limit conditions are satisfied in operations S130 and S150, filling “1” in the matrix is continued.

If the campaign j needs more recommendation in operation S160, the client i is assigned to the campaign j in operation S170. A gain value g_{(i,k)} is adjusted with respect to a campaign k that does not satisfy the limit conditions in operation S180. If the set S is empty or all campaigns satisfy the limit conditions in operation S190, the algorithm ends. Otherwise, the algorithm returns to operation S120.

A campaign-client assignment matrix obtained through such constructive assignment algorithm can be divided into a group of pairs subjected to recommendation (i.e., pairs (client, campaign) assigned “1”) and a group of pairs not subjected to recommendation (i.e., pairs (client, campaign) assigned “0”). If exchange between the two groups gives gain, exchange is performed. The exchange is continued until there is no gain so as to optimize client assignment. The gain obtained by the exchange may be calculated using Formula (2). In such algorithm, a balanced search tree may be used to efficiently maintain and repair gain values. When the campaign j assigned to a client a is newly assigned to a client b, gain is gₐ^{j}+g_{b}^{j}.
gₐ^{j}=R(Hₐ−1)·(σₐ+fⱼ(a))−R(Hₐ)·σₐ
g_{b}^{j}=R(H_{b}−1)·(σ_{b}+fⱼ(b))−R(H_{b})·σ_{b} (2)

Here, gₐ^{j} is a gain when assignment of the campaign j to the client a is cancelled, and g_{b}ⁱ is a gain when the campaign j is newly assigned to the client a.

The above-described method for optimal assignment does not guarantee an optimal result. The multi-campaign assignment with the limit conditions can provide an optimal assignment result by using a dynamic program. The dynamic program is performed on clients sequentially. All cases where a current client can be assigned to campaigns are considered, and an optimal assignment result satisfying all limit conditions is stored. Thereafter, the same operation is performed on a subsequent client. In other words, considering an optimal recommendation state satisfying all limit conditions with respect to all clients before the current client, an optimal value satisfying all limit conditions is obtained with respect to all clients from a first client to the current client. For example; an optimal value satisfying campaign assignment limit conditions with respect to all clients up to a current client i is calculated using Formula (3).
Sᵢ(v)=maxₘ_{ᵢ}(Sᵢ₋₁(v−mᵢ)+R(Hᵢ)·σᵢ) (3)

Here, v is a vector of the campaign assignment limit conditions and mᵢ is a campaign assignment vector with respect to the client i.

The dynamic program is continuously performed up to a last client while maintaining an optimal state, and a matrix is filled according to an optimal result satisfying desired limit conditions. In the dynamic program, the number of campaigns becomes the number of dimensions of an array to be filled. The number of dimensions of the array can be reduced using a Lagrange multiplier.

To optimize client assignment for multiple campaigns, the Lagrange multiplier may be used. When a single Lagrange multiplier is used, the number of array dimensions in the dynamic program can be reduced by one. As such, the number of array dimensions can be reduced by as many as desired. If as many Lagrange multipliers as the number of campaigns are used, an array is not used as illustrated by Formula (4). However, what value is used as a Lagrange multiplier may be important, and a heuristic algorithm or a genetic algorithm may be used to optimize the Lagrange multiplier. Formula (4) shows an optimal value satisfying campaign assignment limit conditions.

$${\sum }_{i = 1}^{N} {F}_{i} + {λ}^{T} p \qquad ( 4 )$$

Here, Fᵢ=maxₘ_{ᵢ}(R(Hᵢ)·σᵢ−λ^{T}mᵢ) is an optimal value of campaign assignment with respect to the client i,

$$p = {\sum }_{i = 1}^{N} {\tilde{m}}_{i}$$

is a vector of the campaign assignment limit conditions, \tilde{m}ᵢ=arg maxₘ_{ᵢ}(R(Hᵢ)·σᵢ−λ^{T}mᵢ) is a campaign assignment vector with respect to the client i, and λ is a vector of Lagrange multipliers as many as the number of campaigns.

In addition to such method of optimizing client assignment for multiple campaigns on a zero base, an incremental assignment optimization method may be used. A marketer continuously performs campaigns. A plurality of marketers may perform their campaigns independently. The following description concerns client assignment when marketer A wants to perform one or more campaigns.

A time window W is set first. W may be set using an input parameter. For example, the time window W may be set to 5 days (i.e., 120 hours). Then, clients that have been assigned to campaigns performed within 120 hours before a time when the marketer A is about to perform campaigns are found out. As such, part of a client-campaign matrix is filled. In a state where the part of the client-campaign matrix is fixed, client assignment for the marketer A's campaigns is optimized considering the fixed part of the client-campaign matrix. In this situation, for clients that were assigned to campaigns within the time window W, the previous assignment history is considered when these clients are assigned to the marketer A's campaigns. The method using the time window W is like the constructive assignment algorithm is performed with a part of a matrix determined in advance.

Generally, when clients are recommended multiple campaigns for a particular period of time, reactivity varies with clients and campaigns. When considering all of these conditions influencing the reactivity, problematic space increases by geometric progression and is thus difficult to be considered practically. For this reason, it is assumed that an initial reactivity function is defined based on the fact that clients show the same reactivity to overlapping recommendation and the fact that the reactivity depends upon only the number of overlapping recommendations. This assumption is reasonable in an initial assignment stage. After assignment results are accumulated, clients may be classified into a plurality of groups and different reactivity functions may be applied to the groups.

The result analyzer 510 performs multiple campaigns and then analyzes clients' reactions and action histories with respect to multi-campaign assignment. The reactivity function can be optimally estimated using a result of the analysis. The more the results of multi-campaign assignment are accumulated, the more the reactivity function can be optimized.

While this invention has been particularly shown and described with reference to preferred embodiments thereof, it will be understood by those skilled in the art that various changes may be made therein without departing from the scope of the invention. Therefore, the above-described embodiments will be considered not in restrictive sense but in descriptive sense only. The scope of the invention will be defined not by the above description but by the appended claims, and it will be construed that all differences made within the scope defined by the claims are included in the present invention.

### INDUSTRIAL APPLICABILITY

As described above, a multi-campaign assignment apparatus considering an overlapping recommendation problem according to the present invention increases client satisfaction and marketing efficiency. When companies perform co-marketing, multi-campaign assignment frequently occurs. In this situation, the present invention is expected to grow co-marketing prosperous and maximize efficiency of the co-marketing.

What is claimed is:

1. A multi-campaign assignment apparatus comprising:
a client preference extractor extracting a client's preference for a campaign based on the client's personal information and the client's action history log;
a reactivity function determiner determining overlapping recommendation when a client is recommended multiple campaigns within a predetermined period of time and determining a reactivity function of client reactivity to overlapping recommendation;
a limit condition provider determining a number of clients to be assigned to each campaign in consideration of the characteristics and environment of each campaign;
a campaign-client assignment evaluator predicting and evaluating a result of assigning clients to a campaign; and
a client selector generating a matrix having clients at a row and campaigns at a column based on client preference, client reactivity, and campaign limit conditions and selecting clients to be recommended a campaign using a client assignment algorithm in a state where no clients are recommended any campaign.

2. The multi-campaign assignment apparatus of claim 1, wherein the client assignment algorithm performed by the client selector is a constructive assignment algorithm comprising:
a matrix initialization module in which “0” is allocated to all elements of an initial matrix;
a gain calculation module in which a gain value with respect to each pair (campaign, client) is calculated; and
a campaign-client assignment module in which assignment is performed with respect to pairs (campaign, client) in descending order of gain values.

3. The multi-campaign assignment apparatus of claim 2, wherein the gain values are calculated using a gain calculation expressed by g_{(i,j)}=R(Hᵢ+1)·(σᵢ+fⱼ(i))−R(Hᵢ)·σᵢ, where g_{(i,j)}is a gain formula when a client i is recommended a campaign j, Hᵢ is the number of recommendations made to the client i, fⱼ(i) is a preference of the client i for the campaign j, σᵢ is the sum of preferences of the client i for campaigns that have been recommended to the client i, and R(Hᵢ) is a reaction rate of the client i with respect to the number of recommendations, Hᵢ.

4. The multi-campaign assignment apparatus of claim 2, wherein the constructive assignment algorithm further comprises a module in which when exchange between an element that has been subjected to the assignment and an element that has not been subjected to the assignment gives gain in a campaign-client assignment matrix made after the campaign-client assignment module, the exchange is repeated until the exchange does not give gain in order to select clients to be recommended a campaign.

5. The multi-campaign assignment apparatus of claim 4, wherein the gain given by the exchange in the constructive assignment algorithm is calculated using:
gₐ^{j}+g_{b}^{j}
gₐ^{j}=R(Hₐ−1)·(σₐ+fⱼ(a))−R(Hₐ)·σₐ
g_{b}^{j}=R(H_{b}−1)·(σ_{b}+fⱼ(b))−R(H_{b})·σ_{b}
where gₐ^{j}+g_{b}^{j} is a gain formula when a campaign j assigned to a client a is newly assigned to a client b, gₐ^{j} is a gain when assignment of the campaign j to the client a is cancelled, and g_{b}^{j} is a gain when the campaign j is newly assigned to the client a.

6. The multi-campaign assignment apparatus of claim 1, wherein the client assignment algorithm performed by the client selector is a dynamic program with respect to a problem in that the limit conditions are used.

7. The multi-campaign assignment apparatus of claim 6, wherein the dynamic program reduces a number of dimensions of the problem using a Lagrange multiplier reducing a number of the limit conditions.

8. The multi-campaign assignment apparatus of claim 7, wherein the Lagrange multiplier uses
$${\sum }_{i = 1}^{N} {F}_{i} + {λ}^{T} p$$
as an optimal value satisfying campaign assignment limit conditions to reduce the number of dimensions of the problem, where Fᵢ=maxₘ_{ᵢ}(R(Hᵢ)·σᵢ−λ^{T}mᵢ) is an optimal value of campaign assignment with respect to the client i,
$$p = {\sum }_{i = 1}^{N} {\tilde{m}}_{i}$$
is a vector of the campaign assignment limit conditions, \tilde{m}ᵢ=arg maxₘ_{ᵢ}(R(Hᵢ)·σᵢ−λ^{T}mᵢ) is a campaign assignment vector with respect to the client i, and λ is a vector of Lagrange multipliers as many as the number of campaigns.

9. The multi-campaign assignment apparatus of claim 7, wherein the client selector combines a heuristic algorithm and a genetic algorithm to optimize the Lagrange multiplier.

10. The multi-campaign assignment apparatus of claim 2, wherein the constructive assignment algorithm performed by the client selector uses a time window and comprises inputting content of assignment of clients to campaigns within the time window among campaigns that have been performed into a matrix in advance and filling the matrix with respect to one or more campaigns to be performed.

11. The multi-campaign assignment apparatus of claim of 1, wherein the reactivity function determiner classifies the clients into groups based on the clients' personal information and action history logs and applies different reactivity functions to the groups, respectively.

12. The multi-campaign assignment apparatus of claim 1, wherein the reactivity function determiner applies different reactivity functions to overlapping recommendations based on campaign attribute information and clients' action history logs with respect to campaigns.

13. The multi-campaign assignment apparatus of claim 1, wherein the reactivity function determiner newly determines the reactivity function based on a result of analyzing a client's reaction to multi-campaign assignment and action history.

14. The multi-campaign assignment apparatus of claim 1, wherein the client selector puts a weight onto a campaign according to importance of the campaign.
